(19) United States
(12) Patent Application Publication
(10) Pub. No.: US 2009/0190587 A1
(43) Pub. Date: Jul. 30, 2009

(54) METHOD FOR DEPLOYING MULTICAST NETWORK, MULTICAST NETWORK AND CONTROL SERVER

(76) Inventors: Gang ZHAO, Hangzhou City (CN); Yang WANG, Hangzhou City (CN); Di ZHOU, Hangzhou City (CN)

Correspondence Address: LADAS & PARRY LLP, 224 SOUTH MICHIGAN AVENUE, SUITE 1600, CHICAGO, IL, 60604, US

(21) Appl. No.: 12/335,880

(22) Filed: Dec. 16, 2008

Related U.S. Application Data
(63) Continuation-in-part of application No. PCT/CN2007/002180, filed on Jul. 17, 2007.

(30) Foreign Application Priority Data
Jul. 17, 2006 (CN) 200610099351.8

(51) Int. Cl. H04L 12/56

(52) U.S. Cl. 370/390

(57) ABSTRACT

The present invention discloses a method for deploying a multicast network, which includes a control server, several multicast sources and clients. The method includes: setting a multicast address pool containing several multicast addresses, determining whether a multicast address is assigned to a multicast source requested to be accessed; if no multicast address is assigned to the multicast source, assigning one multicast address in the multicast address pool to the multicast source, and otherwise, notifying a client requesting a multicast stream of the multicast address so that the client uses the multicast address to set up a connection to the multicast source so as to receive the multicast stream sent by the multicast source. The present invention further discloses a multicast network and control server. According to the present invention, not only multicast address resources but also network bandwidth as well as multicast route table entries of forward devices can be saved.

### FIELD OF THE TECHNOLOGY

The present invention relates to the field of networks, and more particularly, to a method for deploying a multicast network based on Protocol Independent Multicast-Sparse Mode (PIM-SM) protocol, a multicast network and a control server.

### BACKGROUND OF THE INVENTION

During recent years, with the fast popularization and development of Internet, a large number of new applications on the Internet are emerging, including many multimedia applications of high bandwidth, such as online video conferences, online video/audio broadcast, share-list publication, multimedia distance learning, and large-scale collaborative computing. As a result, the problem of much greater bandwidth consumption and network congestion occurs. In order to release the bottleneck of network, various solutions are provided, and as one of the various solutions, the multicast based on an Internet Protocol (IP) routing protocol has particular advantages relatively, which makes bandwidth of Backbone not increase along with the number of users even if the number of the users increases enormously.

The IP routing protocol is a routing control protocol to realize multicast packet forwarding on the third layer of an IP network. The function of the IP routing protocol is to provide routing information for the multicast packet forwarding. The IP routing protocols in common use include Distance Vector Multicast Routing Protocol (DVMRP), Protocol Independent Multicast-Sparse Mode (PIM-SM) and Protocol Independent Multicast-Dense Mode (PIM-DM). Currently, the most popular and mature multicast routing protocol is the PIM-SM protocol.

### SUMMARY

Embodiments of the present invention is to provide a method for deploying a multicast network so as to solve the technical problem of resource waste caused by the prior art in which each multicast source is assigned with a multicast address whether there is a client receiving a multicast stream from the multicast source or not.

The embodiments of the present invention provide a method for deploying a multicast network, wherein the multicast network includes a control server, at least one multicast source and at least one client, the method including:

A) setting a multicast address pool comprising multiple multicast addresses;

B) determining whether a multicast address is assigned to a multicast source requested to be accessed, if no multicast address is assigned to the multicast source, assigning one multicast address in the multicast address pool to the multicast source, and otherwise, performing step C);

C) notifying a client requesting a multicast stream of the multicast address, wherein the client uses the multicast address to set up a connection to the multicast source to receive the multicast stream sent by the multicast source.

The embodiments of the present invention further provide a multicast network deployed with a PIM-SM Protocol, including at least one multicast source, at least one client, and further including: a control server, wherein the control server includes:

an address management unit, adapted to set and maintain a multicast address pool and dynamically assign a multicast address;

a controller, including a request processing unit, wherein,

the request processing unit is adapted to determine whether a multicast address is assigned to a multicast source upon receiving from a client a request for accessing the multicast source, if no multicast address is assigned to the multicast source, notify the address management unit that one multicast address in the multicast address pool is to be assigned to the multicast source and notify the client of the assigned multicast address, and otherwise, send to the client the multicast address assigned.

The embodiments of the present invention further provide a control server, applicable to a multicast network, including:

an address management unit, adapted to set and maintain a multicast address pool and dynamically assign a multicast address;

a controller, including a request processing unit, wherein,

the request processing unit is adapted to determine whether a multicast address is assigned to a multicast source upon receiving from a client a request for accessing the multicast source, if no multicast address is assigned to the multicast source, notify the address management unit that one multicast address in the multicast address pool is to be assigned to the multicast source and notify the client of the assigned multicast address, and otherwise, send to the client the multicast address assigned.

### BRIEF DESCRIPTION OF THE DRAWINGS

FIG. 1 is a schematic diagram illustrating a conventional structure of a multicast network deployed with a PIM-SM protocol.

FIG. 2 is a flowchart illustrating a method for deploying a multicast network in accordance with an embodiment of the present invention.

FIG. 3 is a schematic diagram illustrating a structure of a control server in accordance with an embodiment of the present invention.

FIG. 4 is a schematic diagram illustrating a structure of a monitoring system part in accordance with an embodiment of the present invention.

### DETAILED DESCRIPTION OF EMBODIMENTS

Embodiments of the present invention are described hereinafter with accompanying of the drawings.

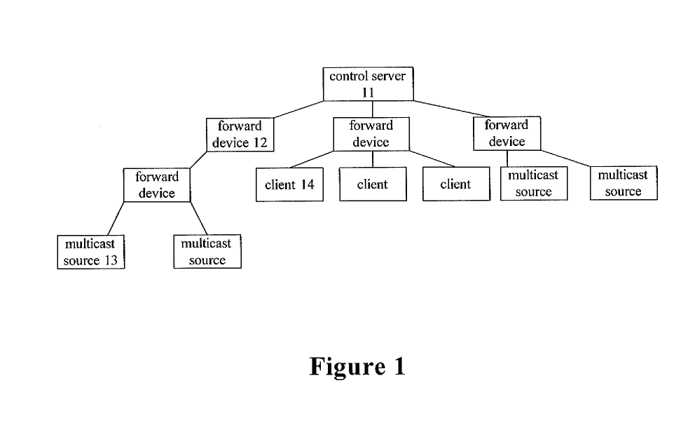

FIG. 1 is a schematic diagram illustrating a structure of a multicast network deployed with the PIM-SM protocol. As shown in FIG. 1, the multicast network includes a control server 11, forward devices 12, multicast sources 13 and a client 14 requesting for receiving a multicast stream. The client 14 may be located in or outside the multicast network. Multicast addresses respectively corresponding to multicast sources are set in the control server 11.

A conventional method for deploying the multicast network includes the following steps:

(1) If the client 14 desires to join a group, it obtains from the control server 11 a multicast address of a multicast source of the group firstly, and then sends an Internet Group Management Protocol (IGMP) membership report message to a forward device connected with the client 14. The IGMP membership report message contains the multicast address obtained in advance.

(2) Upon receiving the IGMP membership report message, the forward device 12 connected with the client 14 (the forward device including a router and a switch) sends a PIM join message to other forward devices in a PIM-SM protocol domain to request receiving the multicast stream of the group.

(3) Multicast route table entries are generated in all forward devices 12 in a path between the forward device connected with the multicast source and the forward device connected with the client initiates a join request.

(4) Upon receiving the multicast stream, the forward device connected with the multicast source sends the multicast stream to the client 14 along the path including all the forward devices 12 according to the multicast route table entries.

If the client does not want to receive the multicast stream of this multicast group, it sends an IGMP leave message. The forward device connected with the client sends a PIM pruning message to other forward devices in the PIM-SM protocol domain, and all the route table entries in all the forward devices in the path between the forward device connected with the multicast source and the forward device connected with the client initiating the join request are aged.

However, the inventor of the present invention finds that, with respect to a multicast source, whether there is a client receiving its multicast stream or not, a multicast address is assigned to it, which leads to the waste of multicast addresses. Particularly when the multicast network is lack of multicast addresses, this waste of multicast addresses greatly increases management costs. For example, if a new multicast source is added to the multicast network and the number of multicast sources exceeds the number of multicast addresses having been assigned to the multicast network, configurations have to be changed, thus increasing the management costs enormously.

A Chinese patent with application No. 200410091190.9 discloses a method for assigning multicast addresses, including the following steps:

10) Static pre-assignment of multicast addresses: dividing a path space into multiple grid units and assigning multicast addresses to these grid units.

20) If the number of objects in a grid unit is over an upper limit of the number of objects in the grid unit, further diving the grid unit into multiple new grid units and assigning multicast addresses to the new grid units, wherein the objects refers to simulation bodies.

30) If the number of objects in a grid unit is below a lower limit of the number of objects in the grid unit, deleting the grid unit and reclaiming the multicast address assigned to it previously.

According to the above method for assigning multicast addresses, the assignment of multicast addresses can be adjusted at any moment according to the number of objects in a grid unit, thus enabling a dynamic assignment of multicast addresses. However, the inventor finds that, it becomes relatively complicated and difficult to be realized if the above method for assigning multicast addresses is applied to the multicast network deployed with the PIM-SM protocol.

A video monitoring system is a classical multicast network deployed with the PIM-SM protocol. The video monitoring system includes a control server 11 and the forward devices 12, and further includes several cameras used as multicast sources and several clients used to receive multicast stream information, such as a TV wall. Each camera may be a multicast source and is assigned with a multicast address. Meanwhile, each camera may also be an unicast source, adapted to save data into a storage device. The control server 11 stores the multicast address as well as the unicast address corresponding to each camera.

The inventor also finds that, the above deploying method applied to the video monitoring system has the following shortcomings:

First, each camera is assigned with a multicast address whether there is a client receiving multicast data from the camera or not, which wastes the multicast address. Particularly, if the multicast network is lack of multicast addresses, this waste of the multicast address increases management costs. Furthermore, if the number of cameras becomes larger than the number of multicast addresses previously assigned to the multicast network since a new camera is added, configurations have to be changed, thus increasing the management costs enormously.

Second, each camera sends the unicast stream and the multicast stream simultaneously. However, the unicast stream must be sent because videos need be stored, while the multicast stream need be sent only when a client orders the multicast stream, in other words, sending the multicast stream is not always needed. Therefore, bandwidth is wasted. In addition, the maximum number of multicast route table entries that a general forward device can support is 1000, and resources of the multicast route table entries are relatively rare for the general forward device, but the useless multicast stream also consumes the resources of the multicast route table entries of the general forward device.

An embodiment of the present invention includes steps: a multicast address pool containing several multicast addresses is set in advance and one multicast address in the multicast address pool is assigned to a multicast source only when the multicast source is requested to be on demand and has not been assigned with any multicast address yet, that is, the multicast source obtains the multicast address dynamically, and thus multicast address resources can be saved. Further, only the multicast source requested to be on demand sends the multicast stream, and therefore, the multicast streams not needed in the network are reduced thereby network bandwidth being saved. Meanwhile, resources of multicast route table entries can also be saved.

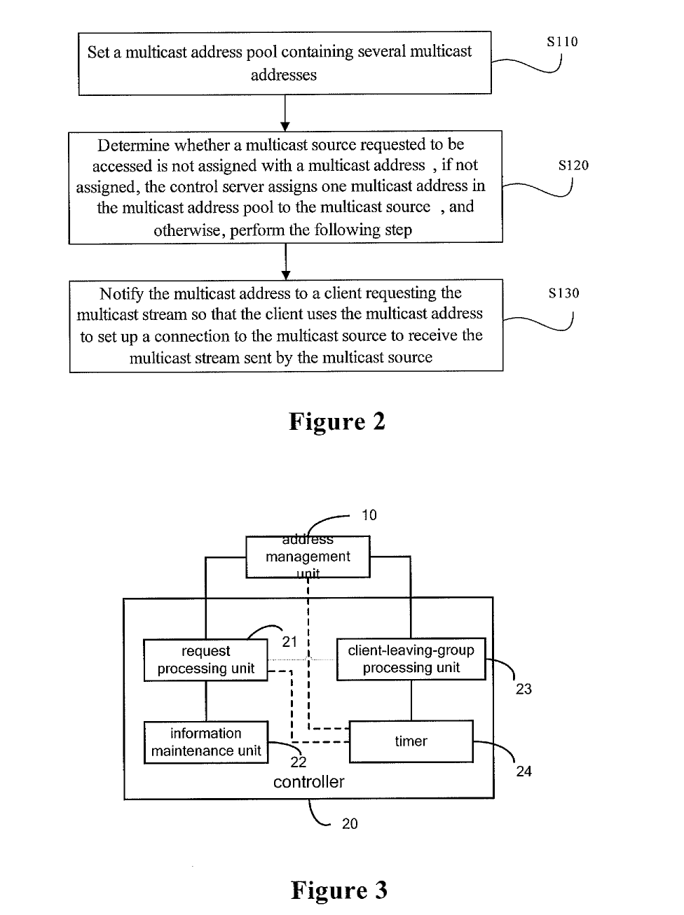

Referring to FIG. 2, it is a flowchart illustrating a method for deploying a multicast network in accordance with an embodiment of the present invention. The multicast network includes a control server, several multicast sources and forward devices, and the flowchart includes the following steps:

S110: Set a multicast address pool containing several multicast addresses, wherein the number of the multicast addresses is larger than or equal to the maximum number of multicast sources requested simultaneously to send multicast streams in the multicast network.

S120: Determine whether a multicast source requested to be accessed (i.e., requested to be on demand) is not assigned with a multicast address, if not assigned, the control server assigns one multicast address in the multicast address pool to the multicast source and triggers the multicast source to send a multicast stream, and otherwise, perform S130.

S130: Notify the multicast address to a client requesting sending the multicast stream so that the client uses the multicast address to set up a connection to the multicast source to receive the multicast stream sent by the multicast source.

Each of the above steps in the embodiment of the present invention will be described in detail hereinafter.

I With Regard to S110

The embodiment of the present invention is applicable to the situation in which not all the multicast sources are simultaneously requested to be on demand, that is, the number of the multicast sources in the multicast network is N1, the maximum number of the multicast sources simultaneously requested to be on demand in the multicast network is N2, and the number of the multicast addresses in the multicast address pool is N3, where N3≦N2<N1. In this situation, the multicast address resources can be saved.

The multicast addresses in the multicast address pool are dynamic. If a multicast source is requested to be on demand and has not been assigned with a multicast address, one multicast address in the multicast address pool is assigned to the multicast source. If no client is receiving the multicast stream sent by the multicast source, the multicast address previously assigned to the multicast source is reclaimed to the multicast address pool.

II With Regard to S120

If the client desires to receive the multicast stream of a multicast source, the client accesses the control server first, and requests to acquire the multicast address of the multicast source. The client may be the host of the multicast network or any other entity in the multicast network. The control server stores and maintains information of all the multicast sources managed by the control server, where the information of the multicast source includes identity of each multicast source and the unicast IP address thereof, and if the multicast source is assigned with a multicast IP address, the information of the multicast source further includes the multicast IP addresses thereof. The client learns in advance the IP address of the multicast source to be ordered. To learn the IP address, the client may search an unicast IP address list of the multicast sources maintained in the corresponding rights by the client, and alternatively, the client may request from the control server the IP address information list of the multicast sources which the client has the right to access to so that the control server temporarily sends the IP address information list to the client. To sum up, the above are only exemplary examples, and any manner that can obtain the identity information of a target device shall be included in the scope of the present invention. The client chooses a target to access from the multicast sources which the client has the right to access to and then requests acquiring the multicast address of the chosen target multicast source from the control server.

If the control server learns that a multicast source is requested to be accessed, the control server searches for information corresponding to the multicast source and determines whether the multicast source has been assigned with a multicast address. If it has not been assigned with any multicast address, the control server searches the multicast address pool to determine whether there is an available multicast address to be assigned. If the multicast address pool is empty, the control server returns error information. And if there is an available multicast address to be assigned, the control server assigns to the multicast source one multicast address in the multicast address pool mentioned in S110 and triggers the multicast source to send a multicast stream, and meanwhile, notifies a client initiating an access request of the multicast address. If the multicast source has been assigned with a multicast address, the control server notifies the client of the multicast address.

In fact, the control server can trigger the multicast source to send the multicast stream just by notifying the multicast source of the multicast address assigned to multicast source. Upon receiving the multicast address, the multicast source starts to send the multicast stream with the multicast address. The control server stores a corresponding relationship between the multicast source and the multicast IP address having been assigned thereto, where, the control server stores a list of information of all the multicast source(s) in its management area, and the information of one multicast source may include the multicast IP address having been assigned to the one multicast source. The list may include the identity of each multicast source and the multicast IP address assigned thereto, or may include the unicast IP address of each multicast source and the IP multicast address assigned thereto. Further, in order to detect whether a client is currently receiving multicast stream data from the multicast source, the control server may set a receiving parameter (i.e. the number of receivers) for the multicast source having been assigned with a multicast address, the receiving parameter being adapted to indicate the number of receivers of the multicast source. Each time a client requests the multicast stream from the multicast source, the control server increases the number of receivers of the multicast source by 1. By this way, the control server can determine whether there is a client receiving the multicast stream sent by the multicast source just by detecting the number of receivers of the multicast source. Alternatively, the control server can determine whether there is a client receiving the multicast stream sent by the multicast source by other manners. For example, the control server detects periodically whether there is a multicast route table entry related to the multicast source in the forward device connected with the multicast source, if there is such multicast route table entry, it means that there is a client receiving the multicast stream sent by the multicast source, and otherwise, it means that there is no client receiving the multicast stream sent by the multicast source.

III With Regard to S130

The client uses the multicast address to send an IGMP membership report message, which contains the multicast address of the multicast source from which the multicast stream data is to be received. Upon receiving the IGMP membership report message, the forward device connected with the client sends a PIM join message to other forward devices in the PIM-SM protocol domain until the PIM join message has been forwarded to the forward device connected directly with the multicast source. Moreover, multicast route table entries are generated respectively in all forward devices in the path between the forward device connected with the multicast source and the forward device connected with the client initiating a join request (i.e., the PIM join message). Upon receiving the multicast stream, the forward device connected with the multicast source forwards the multicast stream along the path including these forward devices according to the multicast route table entries.

If the client does not want to receive the multicast stream of the multicast group any more, the client sends an IGMP leave message. The forward device connected with the client sends a PIM pruning message to other forward devices in the PIM-SM protocol domain, and all the routing route table entries in all the forward devices in the path between the forward device connected with the multicast source and the forward device connected with the client initiating the join request are aged.

When the client leaves a group, the client notifies the control server generally. When the control server learns that the client leaves, the control server detects whether there is a client receiving the multicast stream of the multicast source. If no client is receiving the multicast stream of the multicast source, the control server reclaims the multicast address of the multicast source to the multicast address pool and notifies the multicast source that the sending of the multicast stream is to be stopped.

In S120, the number of receivers of each multicast source that has been assigned with a multicast address is set in the control server, so the control server can detect whether a multicast source has a client receiving its multicast stream currently by detecting whether the number of receivers of the multicast source is 0. Considering the case that the multicast source may be requested to send the multicast stream repeatedly, according to an embodiment of the present invention, the control server waits for a predetermined period of time after detecting that there is no client receiving the multicast stream sent by the multicast source, and if it is determined that no client requests the multicast source to send the multicast stream during the predetermined period of time, the control server reclaims the multicast address of the multicast source to the multicast address pool and notifies the multicast source that the sending of the multicast stream is to be stopped. By the above means, a multicast address for a multicast source would not be assigned or reclaimed frequently in a short period of time, and the control efficiency of the control server is thus improved.

According to the embodiments of the present invention, multiple multicast sources can share the multicast addresses in the multicast address pool and a multicast stream can be sent on demand, which not only saves the multicast address resources and avoids a waste of network bandwidth but also saves the resources of multicast route table entries of the forward devices.

According to the embodiments of the present invention, the above effect may be achieved mainly by updating software of the conventional control server. In other words, the embodiments of the present invention provide a multicast network deployed with the PIM-SM protocol, including at least one forward device, at least one multicast source and a control server. FIG. 3 is a schematic diagram illustrating the structure of the control server. As shown in FIG. 3, the control server includes an address management unit 10 and a controller 20.

The address management unit 10 is adapted to set and maintain a multicast address pool and to dynamically assign a multicast address. The controller 20 includes a request processing unit 21, an information maintenance unit 22, a client-leaving-group processing unit 23, and a timer 24. The request processing unit 21 is adapted to determine whether a multicast address has been assigned to a multicast source upon receiving from a client a request for accessing the multicast source. If not assigned, the request processing unit 21 notifies the address management unit 10 that one multicast address in the multicast address pool is to be assigned to the multicast source, notifies the client of the multicast address and triggers the multicast source to send a multicast stream; and otherwise, the request processing unit 21 directly notifies the client of the multicast address having been assigned. The information maintenance unit 22 is adapted to maintain information of all multicast sources managed by the control server, the information including unicast address information of each multicast source and multicast address information thereof. The information maintenance unit 22 is further adapted to set a receiving parameter for each multicast source having been assigned with a multicast address, where the receiving parameter corresponding to a multicast source is increased by 1 when the address management unit assigns one multicast address to the multicast source while the receiving parameter corresponding to the multicast source is decreased by 1 when the address management unit reclaims one multicast address previously assigned to the multicast source. The client-leaving-group processing unit 23 is adapted to, when a client leaves a multicast group, detect whether there is another client receiving the multicast stream sent by the multicast source of the multicast group, where if no client orders the multicast source (i.e., there is no any other client receiving the multicast stream sent by the multicast source), the client-leaving-group processing unit 23 reclaims the multicast address of the multicast source to the multicast address pool, and notifies the multicast source that the sending of the multicast stream is to be stopped. The timer 24 is adapted to predetermine a period of time upon detecting that there is no client receiving the multicast stream sent by the multicast source, and if it is determined that no client orders the multicast source during the predetermined period of time, reclaim the multicast address of the multicast source to the multicast address pool and notify the multicast source that the sending of the multicast stream is to be stopped. Herein, the timer 24 may start timing upon the client-leaving-group processing unit 23 detects that there is no client receiving the multicast stream sent by the multicast source. The timer 24 may notify the address management unit 10 that the multicast address of the multicast source is to be reclaimed to the multicast address pool if it is determined that no client orders the multicast source during the predetermined period of time, and then the multicast address of the multicast source is reclaimed to the multicast address pool by the address management unit 10, and the timer 24 may trigger the request processing unit 21 to notify the multicast source that the sending of the multicast stream is to be stopped. And alternatively, if it is detected that there is no client receiving the multicast source in the predetermined period of time according to the timing of the timer 24, the client-leaving-group processing unit 23 may notify the address management unit 10 that the multicast address of the multicast source is to be reclaimed to the multicast address pool and trigger the request processing unit 21 to notify the multicast source that sending the multicast stream is to be stopped.

An embodiment of the present invention is described below.

A video monitoring project requests every city to set up monitoring systems in important places such as business units and main traffic lines, and uses storage systems with large capacity to store video data recorded by the monitoring systems. At present, the configuration of a typical city video monitoring project is that: a city bureau manages 20 branches, each branch manages 25 police stations, and each police station is configured with 1K (one thousand) cameras. Each camera is a multicast source and is assigned with a multicast address provided for a monitor to order the multicast source. And each camera is also an unicast source, adapted to save data in a storage device. In addition, each of the city bureau, the branches and the police stations can see pictures captured by any camera. As can be seen, the whole system bears a very large amount of multicast data. Generally, not all the cameras configured in one police station are ordered at the same time, therefore, only these cameras having been ordered need multicast addresses and send multicast streams.

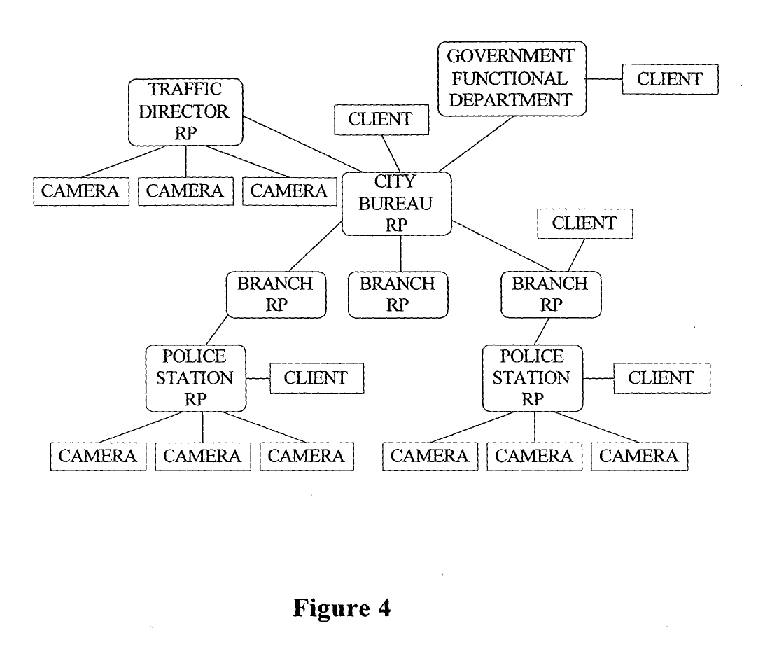

FIG. 4 is a schematic diagram illustrating a structure of a monitoring system part in accordance with an embodiment of the present invention. As shown in FIG. 4, a city bureau manages several branches, each branch manages several police stations, and each police station sets up a Rendezvous Point (RP), a convergence point in the PIM-SM protocol, by itself to provide a RP service for the multicast groups of the cameras belonging to the police station. As each police station is required to arrange 1K cameras, the RP has at least 1K (S, G) items. When each client orders the pictures on a camera, (*, G) route table entries are consequently generated in all routers in a path between the RP and the router connected with the client. A control server, as a control center of the monitoring system, is configured in the monitoring system and records the unicast IP address of each camera as well as the multicast IP address thereof (if a multicast address has been assigned to the camera). Each camera has a coding controller, which has a function of video coding and message interaction with the control server.

When a demander logs on the control server to order pictures of a certain camera, the control server determines whether the camera has been assigned with a multicast address. If not assigned, the control server determines whether the multicast address pool is empty, where if the multicast address pool is empty, the control server returns error information and if it is not empty, the control server assigns one multicast address to the camera. And if the camera has been assigned with a multicast address already, the multicast address is kept using. No matter whether the camera is assigned the multicast address or not, the control server always increases the number of receivers of the camera by 1 and notifies the one which orders the camera's pictures of the multicast address information.

The multicast source uses the obtained multicast address to start to send a multicast stream. The one which orders the camera's pictures sends an IGMP membership report to join the multicast group upon obtaining the multicast address information.

Referring to table 1 below, if one desires to order pictures on camera 2 and the control server finds that no multicast address is assigned to the camera 2, the control server chooses one multicast address from the multicast address pool and assigns the chosen multicast address to camera 2, and notifies the one which orders the pictures on camera 2 of the chosen multicast address and increases the number of receivers of camera 2 by 1. Camera 2 starts to use the multicast address to send a multicast stream, while the one which orders the pictures on camera 2 sends an IGMP membership report and starts to watch the pictures on camera 2.

TABLE 1
an example of a part of contents stored in a storage unit

| | | | The number of |
|---|---|---|---|
| Camera | Unicast Address | Multicast Address | receivers |
| Camera 1 | 10.1.1.1 | 224.1.1.1 | 2 |
| Camera 2 | 10.1.1.2 | NA | 0 |
| Camera 3 | 10.1.1.3 | NA | 0 |

When the one which orders pictures on a camera would turn off the camera, it sends an IGMP leave message. The control server decreases the number of receivers of the camera by 1, and checks whether the number of receivers is 0. If the number of receivers is not 0, which indicates that there is another one which orders the pictures on this camera (i.e., another one is still receiving the multicast stream from the camera), and the control server does not reclaim the multicast address. If the number of receivers is 0, which indicates that no one orders the pictures on this camera, the control server waits for a predetermined period of time, for example 1 minute, and if no one orders the pictures on this camera in the predetermined period of time, e.g., 1 minute, the control server reclaims the multicast address and sends a message to notify the camera 2 that the sending of the multicast stream is to be stopped.

The waiting for the predetermined period of time, e.g., 1 minute, is to avoid that messages are sent frequently between the control server and the camera since the camera is ordered repeatedly. If one orders the camera in the predetermined period of time, e.g., 1 minute, the process is the same as the above, and otherwise, the multicast address is reclaimed.

According to the above multicast control, the monitoring system can save a large number of multicast address resources. Further, the multicast streams that are not needed can be reduced greatly, therefore saving the network bandwidth as well as the resources of multicast route table entries in the forward devices.

According to the above description of the embodiments, it can be clearly understood by those skilled in the art that the embodiments of the present invention can be realized by software accompanying with necessary general hardware platforms, or can be realized by hardware. Based on this, the essential part of the technical solution of the present invention or the part contributed to the prior art can be in the form of a computer software product, and the computer software product is stored in a storage medium and includes several instructions to make a computer device (such as a personal computer, a server or a network device) perform the method in accordance with the embodiments of the present invention.

Compared with the prior art, the present invention has the advantage that multicast address resources can be saved because a multicast address pool containing several multicast addresses is set in advance and one multicast address in the multicast address pool is assigned to a multicast source only when the multicast source is requested to be on demand and has not been assigned with any multicast address yet, that is, the multicast source obtains the multicast address dynamically. Further, only the multicast source requested to be on demand sends the multicast stream, and therefore, the multicast streams that are not needed in the network can be reduced thereby network bandwidth being saved. Meanwhile, resources of multicast route table entries are also saved.

The foregoing is only embodiments of the present invention. The protection scope of the present invention, however, is not limited to the above description. Any change or substitution, easily occurring to those skilled in the art, should be covered by the protection scope of the present invention.

What is claimed is:

1. A method for deploying a multicast network, wherein the multicast network comprises a control server, at least one multicast source and at least one client, the method comprising:
A) setting a multicast address pool comprising multiple multicast addresses;
B) determining whether a multicast address is assigned to a multicast source requested to be accessed, if no multicast address is assigned to the multicast source, assigning one multicast address in the multicast address pool to the multicast source, and otherwise, performing step C);
C) notifying a client requesting a multicast stream of the multicast address, wherein the client uses the multicast address to set up a connection to the multicast source to receive the multicast stream sent by the multicast source.

2. The method for deploying the multicast network according to claim 1, wherein the number of the multicast addresses is no less than the maximum number of multicast sources requested simultaneously to send multicast streams in the multicast network.

3. The method for deploying the multicast network according to claim 1, wherein
the control server maintains a list of information of all multicast sources managed by the control server, wherein the information of one multicast source comprises at least information of a multicast address assigned to the one multicast source; and
the determining in step B) comprises: searching the list to determine whether a multicast address is assigned to the multicast source requested to be accessed.

4. The method for deploying the multicast network according to claim 1, after the client uses the multicast address to set up the connection to the multicast source through forward devices, further comprising:
if it is detected that there is no client receiving the multicast stream sent by the multicast source, reclaiming the multicast address of the multicast source to the multicast address pool and notifying the multicast source that sending the multicast stream is to be stopped.

5. The method for deploying the multicast network according to claim 4, wherein detecting that there is no client receiving the multicast stream sent by the multicast source comprises:
detecting in real time or at intervals whether there is a multicast route table entry of the multicast source in a forward device connected with the multicast source, wherein,
it indicates that there is a client receiving the multicast stream sent by the multicast source if it is detected that there is the multicast route table entry in the forward device; and otherwise, it indicates that there is no client receiving the multicast stream sent by the multicast source.

6. The method for deploying the multicast network according to claim 4, wherein information of the multicast sources maintained by the control server comprises a receiving parameter set for each multicast source having been assigned with a multicast address;
the method further comprises: increasing, by the control server, the receiving parameter of one multicast source by one if assigning one multicast address in the multicast address pool to the one multicast source, and decreasing the receiving parameter of one multicast source of a multicast group by one if a client leaves the multicast group; and,
it is detected that there is no client receiving the multicast stream sent by one multicast source if the receiving parameter of the one multicast source is 0.

7. The method for deploying the multicast network according to claim 4, further comprising:
determining, by the control server, whether the multicast source is requested to be on demand in a predetermined period of time after it is detected that there is no client receiving the multicast stream sent by the multicast source, and,
if the multicast source is not requested to be on demand in the predetermined period of time, reclaiming the multicast address of the multicast source to the multicast address pool and notifying the multicast source that sending the multicast stream is to be stopped.

8. A multicast network deployed with a Protocol Independent Multicast-Sparse Mode (PIM-SM) Protocol, comprising at least one multicast source, at least one client, and further comprising: a control server, wherein the control server comprises:
an address management unit, adapted to set and maintain a multicast address pool and dynamically assign a multicast address;
a controller, comprising a request processing unit, wherein,
the request processing unit is adapted to determine whether a multicast address is assigned to a multicast source upon receiving from a client a request for accessing the multicast source, if no multicast address is assigned to the multicast source, notify the address management unit that one multicast address in the multicast address pool is to be assigned to the multicast source and notify the client of the assigned multicast address, and otherwise, send to the client the multicast address assigned.

9. The multicast network deployed with the PIM-SM Protocol according to claim 8, wherein the controller further comprises:
an information maintenance unit, adapted to maintain information of all multicast sources managed by the control server, wherein the information of one multicast source comprises at least information of a multicast address assigned to the one multicast source.

10. The multicast network deployed with the PIM-SM Protocol according to claim 9, wherein the information maintenance unit in the controller is further adapted to set a receiving parameter for each multicast source assigned with a multicast address, wherein, the receiving parameter for a multicast source is increased by one when the address management unit assigns one multicast address to the multicast source, and the receiving parameter for a multicast source is decreased by one when the address management unit reclaims one multicast address previously assigned to the multicast source.

11. The multicast network deployed with the PIM-SM Protocol according to claim 8, wherein the controller further comprises:
a client-leaving-group processing unit, adapted to detect whether there is a second client receiving the multicast stream sent by the multicast source of a multicast group when the client leaves the multicast group, and reclaim the multicast address of the multicast source to the multicast address pool and notify the multicast source that sending the multicast stream is to be stopped if there is no second client receiving the multicast stream sent by the multicast source.

12. The multicast network deployed with the PIM-SM Protocol according to claim 11, wherein the controller further comprises:
a timer, adapted to predetermine a period of time after it is detected that there is no client receiving the multicast stream sent by the multicast source of the multicast group, reclaim the multicast address of the multicast source to the multicast address pool and notify the multicast source that sending the multicast stream is to be stopped if there is no client receiving the multicast source in the predetermined period of time.

13. The multicast network deployed with the PIM-SM Protocol according to claim 11, wherein the controller further comprises:
a timer, adapted to predetermine a period of time and start timing upon the client-leaving-group processing unit detects that there is no second client receiving the multicast stream sent by the multicast source of the multicast group, and if there is no client receiving the multicast source in the predetermined period of time, notify the address management unit that the multicast address of the multicast source is to be reclaimed to the multicast address pool and trigger the request processing unit to notify the multicast source that sending the multicast stream is to be stopped.

14. The multicast network deployed with the PIM-SM Protocol according to claim 11, wherein the controller further comprises: a timer, adapted to predetermine a period of time and start timing upon the client-leaving-group processing unit detects that there is no second client receiving the multicast stream sent by the multicast source of the multicast group,
the client-leaving-group processing unit is adapted to notify the address management unit that the multicast address of the multicast source is to be reclaimed to the multicast address pool and trigger the request processing unit to notify the multicast source that sending the multicast stream is to be stopped if it is detected that there is no client receiving the multicast source in the predetermined period of time according to the timing of the timer.

15. A control server, applicable to a multicast network, comprising:
an address management unit, adapted to set and maintain a multicast address pool and dynamically assign a multicast address;
a controller, comprising a request processing unit, wherein,
the request processing unit is adapted to determine whether a multicast address is assigned to a multicast source upon receiving from a client a request for accessing the multicast source, if no multicast address is assigned to the multicast source, notify the address management unit that one multicast address in the multicast address pool is to be assigned to the multicast source and notify the client of the assigned multicast address, and otherwise, send to the client the multicast address assigned.

16. The control server according to claim 15, wherein the controller further comprises:
an information maintenance unit, adapted to maintain information of all multicast sources managed by the control server, wherein the information of one multicast source comprises at least information of a multicast address assigned to the one multicast source.

17. The control server according to claim 16, wherein the information maintenance unit in the controller is further adapted to set a receiving parameter for each multicast source assigned with a multicast address, wherein, the receiving parameter for a multicast source is increased by one when the address management unit assigns one multicast address to the multicast source, and the receiving parameter for a multicast source is decreased by one when the address management unit reclaims one multicast address previously assigned to the multicast source.

18. The control server according to claim 13, wherein the controller further comprises:
a client-leaving-group processing unit, adapted to detect whether there is a second client receiving the multicast stream sent by the multicast source of a multicast group when the client leaves the multicast group, and reclaim the multicast address of the multicast source to the multicast address pool and notify the multicast source that sending the multicast stream is to be stopped if there is no second client receiving the multicast stream sent by the multicast source.

19. The control server according to claim 18, wherein the controller further comprises:
a timer, adapted to predetermine a period of time after it is detected that there is no client receiving the multicast stream sent by the multicast source of the multicast group, reclaim the multicast address of the multicast source to the multicast address pool and notify the multicast source that sending the multicast stream is to be stopped if there is no client receiving the multicast source in the predetermined period of time.

20. The control server according to claim 18, wherein the controller further comprises:
a timer, adapted to predetermine a period of time and start timing upon the client-leaving-group processing unit detects that there is no second client receiving the multicast stream sent by the multicast source of the multicast group, and if there is no client receiving the multicast source in the predetermined period of time, notify the address management unit that the multicast address of the multicast source is to be reclaimed to the multicast address pool and trigger the request processing unit to notify the multicast source that sending the multicast stream is to be stopped.
